(19) United States
(12) Patent Application Publication
(10) Pub. No.: US 2026/0135036 A1
(43) Pub. Date: May 14, 2026

(54) MULTILAYER ELECTRONIC COMPONENT

(71) Applicant: SAMSUNG ELECTRO-MECHANICS CO., LTD., Suwon-si (KR)

(72) Inventors: Jin Su KIM, Suwon-si (KR); Young Hoon SONG, Suwon-si (KR); Hyuk Jin HONG, Suwon-si (KR); Kong Joo JEON, Suwon-si (KR); Chul Seung LEE, Suwon-si (KR)

(73) Assignee: SAMSUNG ELECTRO-MECHANICS CO., LTD., Suwon-si (KR)

(21) Appl. No.: 19/324,386

(22) Filed: Sep. 10, 2025

(30) Foreign Application Priority Data
Nov. 14, 2024 (KR) 10-2024-0162184
Apr. 7, 2025 (KR) 10-2025-0044702

(51) Int. Cl. H01G 4/12; H01G 4/008; H01G 4/232; H01G 4/248; H01G 4/30; H01G 13/00

(52) U.S. Cl. CPC H01G 4/1209; H01G 4/008; H01G 4/232; H01G 4/248; H01G 4/30; H01G 13/006

(57) ABSTRACT

A multilayer electronic component includes a body including a capacitance formation portion in which a dielectric layer and an internal electrode are alternately disposed in a first direction; and an external electrode disposed on the body, wherein the capacitance formation portion includes an upper region, a lower region, and a central region disposed between the upper region and the lower region, at least one of dielectric layers disposed in the upper region and the lower region is a first dielectric layer including In, and at least one of dielectric layers disposed in the central region is a second dielectric layer, not including In, or having a lower atomic percentage of average In content than that of the first dielectric layer.

### CROSS-REFERENCE TO RELATED APPLICATION(S)

This application claims benefit of priority to Korean Patent Application Nos. 10-2024-0162184 filed on Nov. 14, 2024 and 10-2025-0044702 filed on Apr. 7, 2025, the disclosures of which are incorporated herein by reference in their entireties.

### TECHNICAL FIELD

The present disclosure relates to a multilayer electronic component.

A multilayer ceramic capacitor (MLCC), a multilayer electronic component, may be a chip-type condenser mounted on the printed circuit boards of various electronic products, such as an imaging device, including a liquid crystal display (LCD) or a plasma display panel (PDP), a computer, a smartphone, or a mobile phone, serving to charge or discharge electricity therein or therefrom.

Such a multilayer ceramic capacitor has a small size, implements high capacitance, and is easily mounted on a circuit board, and may thus be used as a component of various electronic devices.

Recently, as electronic devices are miniaturized and are implemented with high capacitance, with the miniaturization and high performance of electronic devices, and with this trend, the importance of ensuring high reliability of a multilayer ceramic capacitor is increasing. In addition, high reliability characteristics are required for use in automotive electronic components.

Accordingly, there was an attempt to improve reliability of a MLCC by including indium (In) in a dielectric layer. However, when a large amount of In was included in the dielectric layer, a decrease in electrostatic capacitance could occur.

Accordingly, the development of a method to improve reliability while suppressing side effects due to the addition of In is required.

### SUMMARY

An aspect of the present disclosure is to provide a multilayer electronic component having excellent reliability.

An aspect of the present disclosure is to suppress a decrease in electrostatic capacitance due to the addition of indium (In).

However, various problems to be solved by the present disclosure are not limited to the above-described contents, and can be more easily understood in the process of explaining specific embodiments of the present disclosure.

According to an aspect of the present disclosure, a multilayer electronic component includes: a body including a capacitance formation portion in which a dielectric layer and internal electrodes are alternately disposed in a first direction, a first cover portion disposed on a first surface of the capacitance formation portion in the first direction, and a second cover portion disposed on a second surface of the capacitance formation portion opposing the first surface in the first direction; and an external electrode disposed on the body, wherein the capacitance formation portion includes: a first region adjacent to the first cover portion, a second region adjacent to the second cover portion, and a central region disposed between the first region and the second region, the dielectric layer includes: a first plurality of dielectric layers disposed in the first region, a second plurality of dielectric layers disposed in the second region, and a third plurality of dielectric layers disposed in the central region, at least one dielectric layer among the first plurality of dielectric layers and the second plurality of dielectric layers is a first dielectric layer that includes In, and at least one dielectric layer among the third plurality of dielectric layers is a second dielectric layer that (i) is free of In, or (ii) includes In at an average In content, at %, that is lower than an average In content, at %, of the first dielectric layer.

According to another aspect of the present disclosure, a multilayer electronic component includes a body including: a capacitance formation portion in which a dielectric layer and internal electrodes are alternately disposed in a first direction; and an external electrode disposed on the body, wherein the capacitance formation portion includes: a central region, a first region disposed on a first surface of the central region, and a second region disposed on a second surface of the central region, where the second surface of the central region opposes the first surface of the central region in the first direction, the dielectric layer includes: a first dielectric layer having a first average In content at a center of the first dielectric layer in the first direction, where the first dielectric layer is disposed in the first region, the second region, or both, and a second dielectric layer having a second average In content at a center of the first dielectric layer in the first direction, where the second dielectric layer is disposed in the central region, and the first average In content is different from the second average In content.

According to yet another aspect of the present disclosure, a method of manufacturing a multilayer electronic component including applying a first internal electrode paste on a first ceramic green sheet; applying a second internal electrode paste on a second ceramic green sheet; and disposing the first ceramic green sheet, on which the first internal electrode paste is applied, on surfaces of the second ceramic green sheet, on which the second internal electrode paste is applied, to form a laminate, wherein the first internal electrode paste includes In, and an In content of the first internal electrode paste is different from an In content of the second internal electrode paste.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an embodiment of the present disclosure;

FIG. 2 is a schematic cross-sectional view of FIG. 1, taken along line I-I′;

FIG. 3 is a schematic cross-sectional view of FIG. 1, taken along line II-II′;

FIG. 4 is a diagram corresponding to the cross-sectional view illustrated in FIG. 3, illustrating an upper region, a central region, and a lower region of a capacitance formation portion;

FIG. 5 is an enlarged view of region P1 of FIG. 2;

FIG. 6 is an enlarged view of region P2 of FIG. 2;

FIG. 7 is a schematic diagram illustrating first dielectric crystal grains included in a first dielectric layer;

FIG. 8 is a schematic diagram illustrating second dielectric crystal grains included in a second dielectric layer;

FIG. 9 is an image of an upper region and an upper cover portion of Test No. 2, taken with a scanning electron microscope (SEM);

FIG. 10 is an image of a central region of Test No. 2, taken with an SEM; and

FIG. 11 is a diagram illustrating a method for manufacturing the multilayer electronic component of FIG. 1.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, an X-direction may be defined as a first direction, a stacking direction, or a thickness (T) direction, a Y-direction may be defined as a second direction or a length (L) direction, and a Z direction may be defined as a third direction or a width (W) direction.

### Multilayer Electronic Component

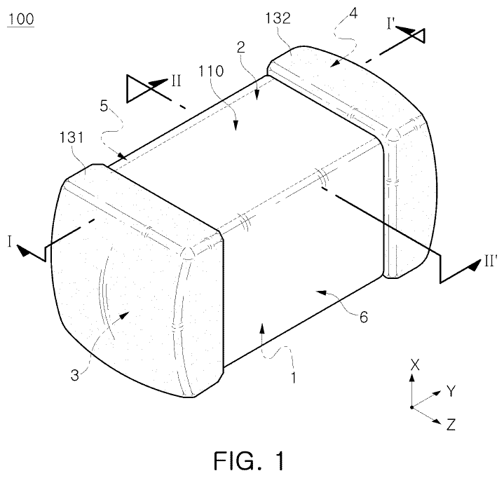

FIG. 1 is a schematic perspective view of a multilayer electronic component according to an embodiment of the present disclosure.

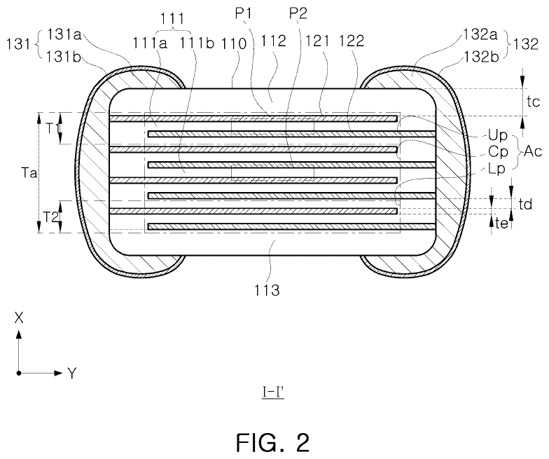

FIG. 2 is a schematic cross-sectional view of FIG. 1, taken along line I-I′.

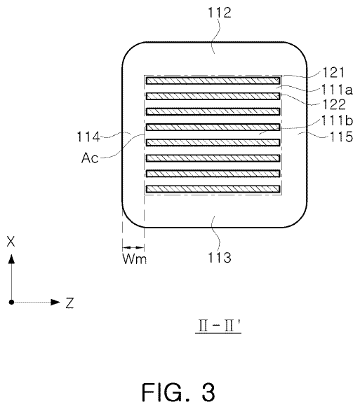

FIG. 3 is a schematic cross-sectional view of FIG. 1, taken along line II-II′.

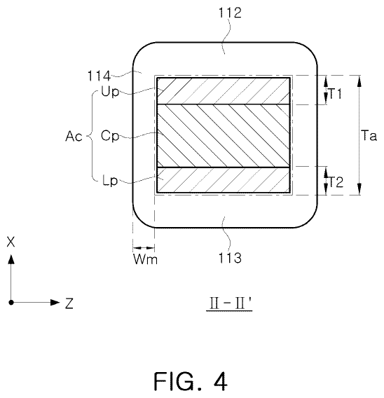

FIG. 4 is a diagram corresponding to the cross-sectional view illustrated in FIG. 3, illustrating an upper region, a central region, and a lower region of a capacitance formation portion.

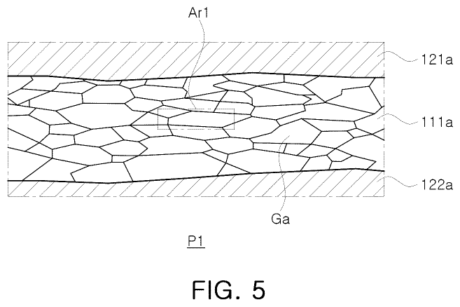

FIG. 5 is an enlarged view of region P1 of FIG. 2.

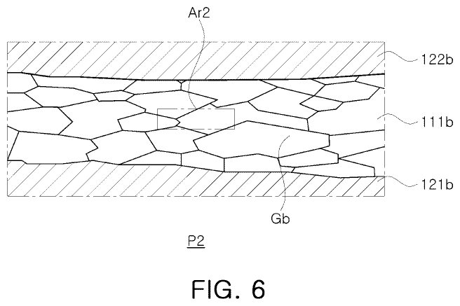

FIG. 6 is an enlarged view of region P2 of FIG. 2.

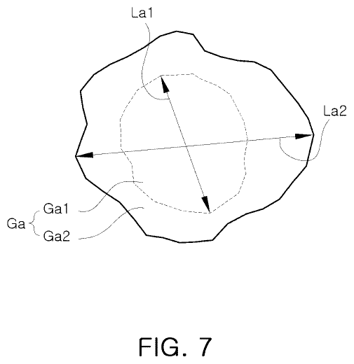

FIG. 7 is a schematic diagram illustrating first dielectric crystal grains included in a first dielectric layer.

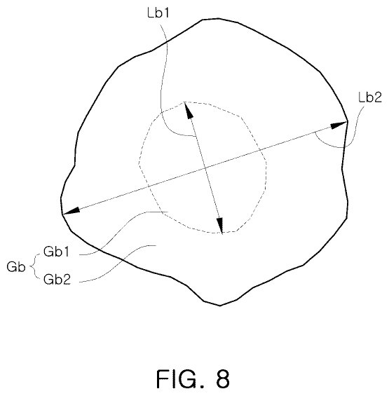

FIG. 8 is a schematic diagram illustrating second dielectric crystal grains included in a second dielectric layer.

Hereinafter, a multilayer electronic component 100 according to an embodiment of the present disclosure will be described in detail with reference to FIGS. 1 to 8.

According to an aspect of the present disclosure, the multilayer electronic component 100 includes a body 110 including a capacitance formation portion (Ac) in which a dielectric layer 111 and internal electrodes 121 and 122 are alternately disposed in a first direction, an upper cover portion 112 (e.g., a first cover portion) disposed above the capacitance formation portion in the first direction, and a lower cover portion 113 (e.g., a second cover portion) disposed below the capacitance formation portion in the first direction; and external electrodes 131 and 132 disposed on the body, wherein the capacitance formation portion (Ac) includes an upper region (Up) (e.g., a first region) adjacent to the upper cover portion, a lower region (Lp) (e.g., a second region) adjacent to the lower cover portion, and a central region (Cp) disposed between the upper region and the lower region, at least one of dielectric layers disposed in the upper region and the lower region may be a first dielectric layer 111a including In, and at least one of dielectric layers disposed in the central region may be a second dielectric layer 111b, not including indium (In), or having a lower atomic percentage of average In content than that of the first dielectric layer.

There have been attempts to improve reliability, such as a mean time to failure (MTTF), insulation resistance (IR), and the like, by including In in a dielectric layer. However, when In is included in the dielectric layer, the reliability of the multilayer electronic component may be improved, but a decrease in electrostatic capacitance could occur.

The present inventors have found that reliability failures mainly occur in the upper and lower regions of the capacitance formation portion and rarely occur in the central region of the capacitance formation portion, and have attempted to improve the reliability of the multilayer electronic component 100 by making at least one of the dielectric layers 111 disposed in the upper region (Up) and lower region (Lp) of the capacitance formation portion a first dielectric layer 111a including In, and at the same time, to suppress a phenomenon of a decrease in electrostatic capacitance by making at least one of the dielectric layers 111 disposed in the central region (Cp) of the capacitance formation portion a second dielectric layer 111b not including In or having a lower atomic percentage of average In content than that of the first dielectric layer.

Hereinafter, each component of the multilayer electronic component 100 according to an embodiment of the present disclosure will be described in detail.

The body 110 may have a dielectric layer 111 and internal electrodes 121 and 122 alternately stacked.

Although the specific shape of the body 110 is not particularly limited, the body 110 may have a hexahedral shape or a shape similar to the hexahedral shape, as illustrated in the drawings. Due to shrinkage of ceramic powder particles included in the body 110 during a sintering process, the body 110 may not have a hexahedral shape having a perfectly straight line, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

As a margin region in which the internal electrodes 121 and 122 are not disposed overlaps the dielectric layer 111, a step portion may be formed by thicknesses of the internal electrodes 121 and 122, so that a corner connecting the first surface to the third to fifth surfaces and/or a corner connecting the second surface to the third to fifth surfaces may have a shape contracted to a center of the body 110 in the first direction when viewed with respect to the first surface or the second surface. Alternatively, by shrinkage behavior during the sintering process of the body 110, a corner connecting the first surface 1 to the third to sixth surfaces 3, 4, 5, and 6 and/or a corner connecting the second surface 2 to the third to sixth surfaces 3, 4, 5, and 6 may have a shape contracted to the center of the body 110 in the first direction when viewed with respect to the first surface or the second surface. Alternatively, as a corner connecting respective surfaces of the body 110 to each other is rounded by performing an additional process to prevent chipping defects, or the like, the corner connecting the first surface to the third to sixth surfaces and/or the corner connecting the second surface to the third to sixth surfaces may have a rounded shape.

Meanwhile, in order to suppress a step portion formed by the internal electrodes 121 and 122, after the internal electrodes are cut so as to be exposed to the fifth and sixth surfaces 5 and 6 of the body after lamination, when margin portions 114 and 115 are formed by stacking a single dielectric layer or two or more dielectric layers on both side surfaces of the capacitance formation portion (Ac) in a third direction (width direction), a portion connecting the first surface to the fifth and sixth surfaces and a portion connecting the second surface to the fifth and sixth surfaces may not have a contracted form.

A plurality of dielectric layers 111 forming the body 110 may be in a sintered state, and adjacent dielectric layers 111 may be integrated with each other, such that boundaries therebetween may not be readily apparent without use of a scanning electron microscope (SEM).

According to an embodiment of the present disclosure, a raw material for forming the dielectric layer 111 is not particularly limited, as long as sufficient electrostatic capacitance may be obtained therewith. For example, the raw material for forming the dielectric layer 111 may be a barium titanate (BaTiO₃)-based material, a lead composite perovskite-based material, a strontium titanate (SrTiO₃)-based material, or the like. The barium titanate-based material may include BaTiO₃-based ceramic powder, and the ceramic powder may be, for example, BaTiO₃, (Ba₁₋ₓCaₓ)TiO₃, Ba(Ti_{1-y}Ca_{y})O₃, (Ba₁₋ₓCaₓ)(Ti_{1-y}Zr_{y})O₃ or Ba(Ti_{1-y}Zr_{y})O₃, in which calcium (Ca), zirconium (Zr), or the like, are partially dissolved in BaTiO₃, and the like.

In addition, the raw material of the dielectric layer 111 may include various ceramic additives, organic solvents, binders, dispersants, and the like, added to powder particles such as barium titanate (BaTiO₃) powder particles, or the like, according to an object of the present disclosure.

Meanwhile, a ceramic green sheet for forming the first dielectric layer 111a may further include In as an additive, and a ceramic green sheet for forming the second dielectric layer 111b may not include In. However, the present disclosure is not limited thereto, and instead of including In as an additive in the ceramic green sheet for forming the first dielectric layer 111a, In is added to a paste for an internal electrode for forming the internal electrode and In is diffused into the dielectric layer during the sintering process, so that the first dielectric layer 111a includes In.

Meanwhile, an average thickness “td” of the dielectric layer 111 is not particularly limited, and may be arbitrarily set according to the desired characteristics or purpose. For a specific example, the average thickness “td” of the dielectric layer 111 may be 300 nm or more and 10 μm or less. In addition, the average thickness “td” of at least one of the plurality of dielectric layers 111 may be 300 nm or more and 10 μm or less.

Here, the average thickness “td” of the dielectric layer 111 may mean an average thickness of the dielectric layer 111 disposed between the first and second internal electrodes 121 and 122.

The average thickness of the dielectric layer 111 may be measured from an image obtained by scanning a cross-section of the body 110 in the length and thickness directions (L-T directions) with a scanning electron microscope (SEM) at a magnification of 10,000. More specifically, an average value may be measured by measuring a thickness of one dielectric layer at 30 equally spaced points in the length direction from the scanned image. The 30 equally spaced points may be designated in the capacitance formation portion (Ac). In addition, if the average value is measured by extending the average value measurement to 10 dielectric layers, the average thickness of the dielectric layers may be further generalized.

The body 110 may include a capacitance formation portion (Ac) in which a dielectric layer and internal electrodes are alternately disposed in a first direction, and cover portions 112 and 113 disposed above and below the capacitance formation portion in the first direction.

The cover portions 112 and 113 may include an upper cover portion 112 disposed above the capacitance formation portion (Ac) in the first direction and a lower cover portion 113 disposed below the capacitance formation portion (Ac) in the first direction.

The capacitance formation portion (Ac) is a portion serving to contribute to capacitance formation of a capacitor, and may be formed by repeatedly stacking a plurality of first and second internal electrodes 121 and 122 with the dielectric layer 111 interposed therebetween.

The cover portions 112 and 113 may be formed by stacking a single dielectric layer 111 or two or more dielectric layers 111 on the upper and lower surfaces of the capacitance formation portion (Ac) in a thickness direction, respectively, and the cover portions 112 and 113 may serve to basically prevent damage to the internal electrodes due to physical or chemical stress.

The capacitance formation portion (Ac) may include an upper region (Up) adjacent to the upper cover portion, a lower region (Lp) adjacent to the lower cover portion, and a central region (Cp) disposed between the upper region and the lower region, at least one of dielectric layers disposed in the upper region and the lower region may be first dielectric layer 111a including In, and at least one of dielectric layers disposed in the central region may be a second dielectric layer 111b, not including In, or having a lower atomic percentage of average In content than that of the first dielectric layer.

The dielectric layer 111 may include a first dielectric layer 111a including In and a second dielectric layer 111b, not including In, or having a lower atomic percentage of average In content than that of the first dielectric layer. The first dielectric layer 111a may be disposed in at least one of the upper region (Up) and the lower region (Lp) of the capacitance formation portion, and the second dielectric layer 111b may be disposed in the central region (Cp) of the capacitance formation portion.

By making at least one of the dielectric layers 111 disposed in the upper region (Up) and lower region (Lp) of the capacitance formation portion a first dielectric layer 111a including In, the reliability of the multilayer electronic component 100 may be improved, and at the same time, by making at least one of the dielectric layers 111 disposed in the central region (Cp) of the capacitance formation portion a second dielectric layer 111b, not including In, or having a lower atomic percentage of average In content than that of the first dielectric layer, a phenomenon of a decrease in electrostatic capacitance can be suppressed.

In an embodiment, the first dielectric layer 111a may have an average In content of 0.08 at % or more, measured at a center of the first dielectric layer 111a in the first direction, and the second dielectric layer 111b may have an average In content of 0.04 at % or less, measured at a center of the second dielectric layer 111b in the first direction. Accordingly, the effect of suppressing a decrease in electrostatic capacitance while improving the reliability according to the present disclosure may be further improved.

Since the average In content measured at the center of the second dielectric layer 111b in the first direction is 0.04 at % or less, the effect of suppressing the decrease in electrostatic capacitance of the multilayer electronic component may be further improved.

In addition, when the average In content measured at the center of the second dielectric layer 111b in the first direction is 0.01 at % or less, the effect of suppressing the decrease in electrostatic capacitance of the multilayer electronic component may be further improved. In this case, it can be determined that the second dielectric layer 111b substantially does not include In.

In an embodiment, an average In content measured at the center of the first dielectric layer 111a in the first direction may be 0.08 at % or less and 0.12 at % or less. Since the average In content measured at the center of the first dielectric layer 111a in the first direction may be 0.08 at % or more, the reliability of the multilayer electronic component may be further improved. Meanwhile, an upper limit thereof is not particularly limited, but for example, the first dielectric layer 111a may have an average In content of 0.08 at % or more and 0.12 at % or less, measured at the center in the first direction.

In addition, an atomic percentage of the average In content measured at the center of the first dielectric layer 111a in the first direction may be at least twice an atomic percentage of the average In content measured at the center of the second dielectric layer 111b in the first direction.

A method for measuring the In content of the first dielectric layer 111a and the second dielectric layer 111b is not particularly limited.

For example, after polishing the multilayer electronic component to a center thereof in a width direction to expose a cross-section of the multilayer electronic component in the length and thickness directions (L-T cross-section), an In content of the first dielectric layer 111a and the second dielectric layer 111b in the L-T cross-section may be measured by analyzing the first dielectric layer 111a and the second dielectric layer 111b by scanning electron microscopy with energy-dispersive x-ray spectroscopy (SEM-EDS). As shown in FIG. 5, by analyzing an Ar1, which is a central region of the first dielectric layer in the thickness direction by SEM-EDS, an at % of an average In content, measured at the center of the first dielectric layer 111a in the first direction may be obtained, and as shown in FIG. 6, by analyzing an Ar2, which is a central region of the second dielectric layer in the thickness direction by SEM-EDS, an at % of an average In content, measured at the center of the second dielectric layer 111b in the first direction may be obtained. Other methods and/or tools appreciated by one of ordinary skill in the art, even if not described in the present disclosure, may also be used.

In addition, the at % of the In content may be expressed as a percentage of the number of In atoms among the total number of atoms disposed in the measurement regions Ar1 and Ar2.

The first dielectric layer 111a may include a plurality of first dielectric crystal grains (Ga), and the second dielectric layer 111b may include a plurality of second dielectric crystal grains (Gb).

An average size of the plurality of first dielectric crystal grains (Ga) may be smaller than an average size of the plurality of second dielectric crystal grains (Gb). Accordingly, the effect of improving the reliability by the first dielectric layer 111a may be further improved.

A size of dielectric crystal grains may mean an arithmetic mean of a maximum Feret Diameter and a minimum Feret Diameter of dielectric crystal grains. An average size of dielectric crystal grains may be a value obtained by averaging the sizes of 100 or more dielectric crystal grains.

A Feret Diameter means a distance between two parallel lines that completely includes a dielectric crystal grain, when a peripheral portion of the dielectric crystal grain are projected from a specific direction. Among the Feret diameter values measured in all possible directions of the dielectric crystal grains, the largest value is a maximum Feret Diameter, and the smallest value is a minimum Feret Diameter.

In addition, the maximum Feret diameter, minimum Feret diameter, and size of the dielectric crystal grains may be measured in the L-T cross-section, after polishing the multilayer electronic component to the center in the width direction to expose the cross-section in the length and thickness directions (L-T cross-section). By analyzing an image obtained by scanning the L-T cross-section with a scanning electron microscope (SEM) using image analysis software such as ImageJ, the maximum and minimum Feret diameters of each dielectric crystal grain may be obtained, the size of each dielectric crystal grain may be obtained, and the average size of 100 or more dielectric crystal grains may be used as the average size of the dielectric crystal grains. Other methods and/or tools appreciated by one of ordinary skill in the art, even if not described in the present disclosure, may also be used.

Referring to FIGS. 7 and 8, a first dielectric crystal grain (Ga) and a second dielectric crystal grain (Gb) may have a core-shell structure. However, an embodiment thereof is not limited thereto, and the first dielectric crystal grain (Ga) and the second dielectric crystal grain (Gb) may be comprised of only a core, or may have a core-double shell structure.

The first dielectric grain (Ga) may include a first core (Ga1) and a first shell (Ga2) surrounding at least a portion of the first core (Ga1), and the second dielectric grain (Gb) may include a second core (Gb1) and a second shell (Gb2) surrounding at least a portion of the second core (Gb1).

A size of the first core (Ga1) may be larger than a size of the second core (Gb1). A size of the core may be an arithmetic mean of the maximum ferret diameter and the minimum ferret diameter of the core. A maximum ferret diameter (La1) of the first core (Ga1) may be larger than a maximum ferret diameter (Lb1) of the second core (Gb1). In addition, a maximum ferret diameter (La2) of the first dielectric grain (Ga) may be smaller than a maximum ferret diameter (Lb2) of the second dielectric grain (Gb). Accordingly, an area fraction occupied by the first core (Ga1) in the first dielectric crystal grain (Ga) may be greater than an area fraction occupied by the second core (Gb1) in the second dielectric crystal grain (Gb). This may be due to a difference in the In content included in the dielectric layer.

In an embodiment, an average size of the dielectric crystal grains (Ga) included in the first dielectric layer 111a may be smaller than an average size of the dielectric crystal grains (Gb) included in the second dielectric layer 111b, and an average size of a core of the dielectric crystal grains of the core-shell structure included in the first dielectric layer 111a may be larger than an average size of a core of the dielectric crystal grains of the core-shell structure included in the second dielectric layer 111b.

The maximum Ferret diameter, minimum Ferret diameter and size of the core may also be measured similarly to a method for measuring the maximum Ferret diameter, minimum Ferret diameter and size of the dielectric crystal grains described above. Meanwhile, the cores Ga1 and Gb1 and the shells Ga2 and Gb2 may be distinguished into a region in which a content of an additive is less than 0.2 mol per 100 mol of Ti as the cores Ga1 and Gb1, and a region in which a content of the additive is more than 0.2 mol per 100 mol of Ti as the shells Ga2 and Gb2.

In an embodiment, a dielectric layer disposed in the upper region (Up) and the lower region (Lp) may have an average In content of 0.08 at % or more measured at the center in the first direction, and a dielectric layer disposed in the center region (Cp) may have an average In content of 0.04 at % or less measured at the center in the first direction. That is, the dielectric layer disposed in the upper region (Up) and the lower region (Lp) may be a first dielectric layer 111a, and the dielectric layer disposed in the central region (Cp) may be a second dielectric layer 111b. Accordingly, the effect of suppressing a decrease in electrostatic capacitance, while improving the reliability according to the present disclosure may be further improved.

Meanwhile, in FIG. 2, it is illustrated that two internal electrodes and two dielectric layers are disposed in the upper region (Up) and the lower region (Lp), respectively. However, this is only a simplified illustration, and two or more internal electrodes and two or more dielectric layers may be disposed in the upper region (Up) and the lower region (Lp), respectively.

In an embodiment, the dielectric layer disposed in the upper region (Up) and the lower region (Lp) may have an average In content of 0.08 at % or more and 0.12 at % or less measured at the center in the first direction, and the dielectric layer disposed in the center region (Cp) may have an average In content of 0.01 at % or less measured at the center in the first direction.

In an embodiment, when an average thickness of the capacitance formation portion (Ac) in the first direction is Ta, an average thickness of the upper region (Up) in the first direction is T1, and an average thickness of the lower region (Lp) in the first direction is T2, (T1+T2)/Ta may be 0.3 or more and 0.7 or less. Accordingly, the effect of suppressing the decrease in electrostatic capacitance, while improving the reliability according to the present disclosure may be further improved.

When (T1+T2)/Ta is less than 0.3, it may be difficult to further improve reliability, and when (T1+T2)/Ta is more than 0.7, it may be difficult to further improve the effect of suppressing the decrease in electrostatic capacitance.

In addition, the Ta, T1 and T2 can satisfy 0.15≤T1/Ta≤0.35 and 0.15≤T2/Ta≤0.35.

The Ta, T1 and T2 may be measured by observing the L-T cross section after polishing the multilayer electronic component to the center of the multilayer electronic component in the width direction to expose a cross-section thereof in the length and thickness direction (L-T cross section) under a microscope (e.g., optical microscope or electron microscope. Other methods and/or tools appreciated by one of ordinary skill in the art, even if not described in the present disclosure, may also be used.

The average thickness (Ta) of the capacitance formation portion (Ac) in the first direction may be a value obtained by averaging thicknesses from a boundary surface between the capacitance formation portion and an upper cover portion to a boundary surface between the capacitance formation portion and a lower cover portion, measured at 5 equally spaced points in the length direction in the L-T cross section.

In the case of the average thickness (T1) of the upper region (Up) in the first direction and the average thickness (T2) of the lower region (Lp) in the first direction, after the capacitance formation portion (Ac) is divided into an upper region (Up), a central region (Cp), and a lower region (Lp) by the method of measuring the In content of the dielectric layer described above, a value obtained by averaging thicknesses of the upper region (Up) in the first direction, measured at 5 equally spaced points in the length direction may be T1, and a value obtained by averaging thicknesses of the lower region (Lp) in the first direction, measured at 5 equally spaced points in the length direction may be T2.

However, Ta, T1 and T2 do not need to be measured in the L-T cross section, and may be measured in the W-T cross section as shown in FIG. 4.

In an embodiment, an atomic percentage of the average In content measured at the center of the dielectric layer in the first direction disposed in the upper region (Up) and the lower region (Lp) may be at least twice an atomic percentage of the average In content measured at the center of the dielectric layer in the first direction disposed in the central region (Cp). Accordingly, the effect of suppressing the decrease in electrostatic capacitance, while improving the reliability according to the present disclosure, may be further improved.

In an embodiment, an average grain diameter of the dielectric crystal grains included in the upper region (Up) and the lower region (Lp) may be smaller than average grain diameter of the dielectric crystal grains included in the central region (Cp). Accordingly, the effect of suppressing the decrease in electrostatic capacitance, while improving the reliability according to the present disclosure, may be further improved.

In an embodiment, the dielectric layer 111 includes dielectric crystal grains of a core-shell structure, and an average value of the maximum Feret diameters of the cores of the dielectric crystal grains of the core-shell structure included in the upper region (Up) and the lower region (Lp) may be greater than an average value of the maximum Feret diameters of the cores of the dielectric crystal grains of the core-shell structure included in the central region (Cp). An area fraction occupied by the core in the dielectric crystal grains of the core-shell structure included in the upper region (Up) and the lower region (Lp) may be greater than an area fraction occupied by the core in the dielectric crystal grains of the core-shell structure included in the central region (Cp). This may be due to the difference in the In content included in the dielectric layer.

Since the dielectric layers disposed in the upper region (Up) and the lower region (Lp) contain a larger amount of In than the dielectric layer disposed in the central region (Cp), the formation of a secondary phase may be suppressed. Here, the secondary phase may mean that a separate phase having a different crystal structure or chemical composition from a main component is formed when the main component and additives react or during the sintering process. The secondary phase may be detected by SEM-EDS. Other methods and/or tools appreciated by one of ordinary skill in the art, even if not described in the present disclosure, may also be used.

Accordingly, the dielectric layer 111 includes a secondary phase, but at least one of the dielectric layers disposed in the upper region (Up) and the lower region (Lp) may have a smaller average number of secondary phases than at least one of the dielectric layers disposed in the central region (Cp).

In addition, the dielectric layer 111 may include a secondary phase, but an average area of the secondary phase included in at least one of the dielectric layers disposed in the upper region and the lower region may be smaller than an average area of the secondary phase included in at least one of the dielectric layers disposed in the central region.

In an embodiment, average porosity of at least one of the dielectric layers disposed in the upper region and the lower region may be lower than average porosity of at least one of the dielectric layers disposed in the central region.

The average number of secondary phases, the average area of the secondary phases, and the average porosity of the dielectric layer may be measured by SEM-EDS in the L-T cross-section after polishing the multilayer electronic component to the center in the width direction to expose the cross-section in the length and thickness directions (L-T cross-section), and may be a value obtained by averaging the values measured in three unit areas (100 μm², 10 μm×10 μm). Other methods and/or tools appreciated by one of ordinary skill in the art, even if not described in the present disclosure, may also be used.

The cover portions 112 and 113 may not include internal electrodes, and the cover portions 112 and 113 may include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), in which calcium (Ca), zirconium (Zr), or the like, are partially dissolved in BaTiO₃, and the like.

In an embodiment, the average In content measured at the center of the upper cover portion 112 and the lower cover portion 113 in the first direction may be 0.04 at % or less. In addition, the upper cover portion 112 and the lower cover portion 113 may substantially not contain In. That is, the upper cover portion 112 and the lower cover portion 113 may have a component similar to that of the second dielectric layer 111b.

Meanwhile, there is no need to specifically limit a method for controlling an In content of the dielectric layer depending on the position. For example, the In content included in the ceramic green sheet may be controlled differently depending on the position, or the In content included in the paste for internal electrodes applied to the ceramic green sheet may be controlled differently depending on the position, and both methods may be applied simultaneously.

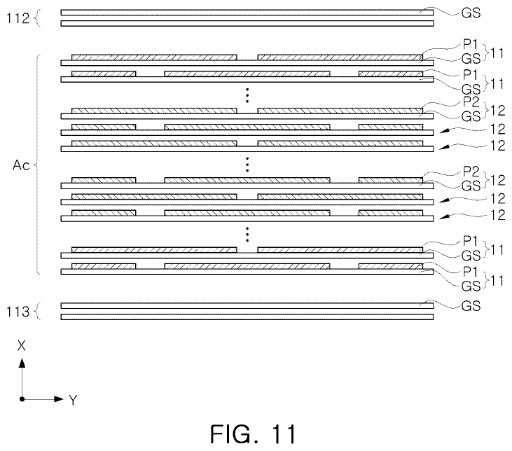

FIG. 11 is a diagram, illustrating a method for manufacturing the multilayer electronic component of FIG. 1. Referring to FIG. 11, as a specific example, one or more ceramic green sheets GS to which a paste for an internal electrode is not applied in upper and lower portions thereof in the first direction may be stacked, respectively, so that the cover portions 112 and 112 may be stacked, a ceramic green sheet 11 to which a paste for an internal electrode P1 having a high In content may be disposed below the upper cover portion 112 in the first direction and above the lower cover portion 113 in the first direction may be disposed, and a ceramic green sheet 12 to which a paste for an internal electrode P2 is applied having a low In content or no In content may be disposed therebetween, so that the capacitance formation portion (Ac) may be stacked, thereby forming a laminate. Thereafter, the laminate is cut to fit the size of the multilayer electronic component and then fired to form a body, and an external electrode is formed on the body to manufacture a multilayer electronic component.

Meanwhile, the In content of the paste for the internal electrode P1 having a high In content is not particularly limited. For example, the In content of the paste for the internal electrode P1 may be 0.5 to 1.5 wt %.

Meanwhile, an average thickness of the cover portions 112 and 113 is not particularly limited. For example, a thickness “tc” of the cover portions 112 and 113 may be 10 to 300 μm. However, in order to more easily implement miniaturization and high capacitance of the multilayer electronic component, an average thickness “tc” of the cover portions 112 and 113 may be 15 μm or less. That is, the average thickness “tc” of the upper cover portion 112 may be 15 μm or less, and the average thickness “tc” of the lower cover portion 113 may also be 15 μm or less.

The average thickness “tc” of the cover portions 112 and 113 may mean a size thereof in a first direction, and may be a value obtained by averaging sizes of the cover portions 112 and 113 measured at 5 equally spaced points above or below the capacitance formation portion (Ac).

In addition, margin portions 114 and 115 may be disposed on a side surface of the capacitance formation portion (Ac).

The margin portions 114 and 115 may include a first margin portion 114 disposed on the fifth surface 5 of the body 110 and a second margin portion 115 disposed on the sixth surface 6 thereof. That is, the margin portions 114 and 115 may be disposed on both end surfaces of the body in a width direction.

The margin portions 114 and 115 may mean a region between both ends of the first and second internal electrodes 121 and 122 and an interface of the body 110 in a cross-section cut of the body 110 in a width-thickness (W-T) direction, as illustrated in FIG. 3.

The margin portions 114 and 115 may basically serve to prevent damages to the internal electrodes due to physical or chemical stresses.

The margin portions 114 and 115 may be formed by applying a conductive paste to the ceramic green sheet, except where margin portions are to be formed, to form an internal electrode.

In addition, in order to suppress a step by the internal electrodes 121 and 122, after the internal electrodes are cut so as to be exposed to the fifth and sixth surfaces 5 and 6 of the body after lamination, the margin portions 114 and 115 may also be formed by stacking a single dielectric layer or two or more dielectric layers on both side surfaces of the capacitance formation portion (Ac) in the third direction (width direction).

Meanwhile, a width of the margin portions 114 and 115 is not particularly limited. For example, the width of the margin portions 114 and 115 may be 5 to 300 μm. However, in order to more easily implement miniaturization and high capacitance of the multilayer electronic component, an average width “Wm” of the margin portions 114 and 115 may be 15 μm or less.

The average width “Wm” of the margin portions 114 and 115 may mean an average size of the margin portions 114 and 115 in a third direction, and may be a value obtained by averaging sizes of the margin portions 114 and 115 measured at 5 equally spaced points in the third direction on one side surface of the capacitance formation portion (Ac).

Internal electrodes 121 and 122 may be alternately stacked with the dielectric layer 111.

The internal electrodes 121 and 122 may include first and second internal electrodes 121 and 122. The first and second internal electrodes 121 and 122 may be alternately disposed to oppose each other with the dielectric layer forming the body 110 interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body to be connected to the first internal electrode 121, and a second external electrode 132 may be disposed on the fourth surface 4 of the body to be connected to the second internal electrode 122.

That is, the first internal electrode 121 is not connected to the second external electrode 132, but is connected to the first external electrode 131, and the second internal electrode 122 is not connected to the first external electrode 131, but is connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance.

In this case, the first and second internal electrodes 121 and 122 may be electrically isolated from each other by the dielectric layer 111 disposed in a middle.

Meanwhile, the internal electrodes 121 and 122 may include a 1-1 internal electrode 121a and a 2-1 internal electrode 122a disposed with a first dielectric layer 111a therebetween. In this case, the 1-1 internal electrode 121a and the 2-1 internal electrode 122a may include Ni and In, and at least a portion of In included in the 1-1 internal electrode 121a and the 2-1 internal electrode 122a may exist in an alloy form with Ni. This may be due to the fact that since In is added to a first conductive paste P1 for forming the 1-1 internal electrode 121a and the 2-1 internal electrode 122a, In diffuses to an interface with the dielectric layer during the sintering process and remains partially in the internal electrode to form an alloy with Ni. Whether Ni and In exist in an alloy form may be confirmed by whether a peak position of Ni has shifted when analyzed by X-ray diffraction (XRD). For example, after the internal electrode is pulverized to obtain a powder, the powder may be analyzed by XRD to determine whether the peak position of Ni has shifted.

However, an embodiment thereof is not limited thereto, and all of the In included in the conductive paste for forming the 1-1 internal electrode 121a and the 2-1 internal electrode 122a may diffuse into the first dielectric layer 111a, and the 1-1 internal electrode 121a and the 2-1 internal electrode 122a may substantially not include In.

In addition, it may include a 1-2 internal electrode 121b and a 2-2 internal electrode 122b disposed with a second dielectric layer 111b therebetween. The 1-2 internal electrode 121b and the 2-2 internal electrode 122b may have an In content of 0.04 at % or less, and may substantially not contain In.

Meanwhile, an average thickness “the” of the internal electrodes 121 and 122 is not particularly limited, and may be arbitrarily set according to the desired characteristics or purpose. For a specific example, the average thickness “the” of the internal electrodes 121 and 122 may be 300 nm or more and 3 μm or less. In addition, the average thickness “the” of at least one of the plurality of internal electrodes 121 and 122 may be 300 nm or more and 3 μm or less.

The thickness of the internal electrodes 121 and 122 may mean a size of the internal electrodes 121 and 122 in the first direction. The average thickness of the internal electrodes 121 and 122 may be measured from an image obtained by scanning a cross-section of the body 110 in the length and thickness directions (L-T) with a scanning electron microscope (SEM) at a magnification of 10,000. More specifically, an average value of one internal electrode may be measured by measuring a thickness of one internal electrode at 30 equally spaced points in the length direction in the scanned image. The 30 equally spaced points can be designated in the capacitance formation portion (Ac). In addition, when the average value measurement is extended to 10 internal electrodes and the average value is measured, the average thickness of the internal electrodes may be further generalized.

External electrodes 131 and 132 may be disposed on the third surface 3 and the fourth surface 4 of the body 110.

The external electrodes 131 and 132 may include first and second external electrodes 131 and 132 respectively disposed on the third and fourth surfaces 3 and 4 of the body 110, to be respectively connected to the first and second internal electrodes 121 and 122.

In the present embodiment, a structure in which the multilayer electronic component 100 has two external electrodes 131 and 132 is described. However, the number and shape of the external electrodes 131 and 132 may be changed according to the shape of the internal electrodes 121 and 122 or other purposes.

Meanwhile, the external electrodes 131 and 132 may be formed of any material having electrical conductivity, such as metal, and a specific material may be determined in consideration of electrical properties and structural stability, and the external electrodes 131 and 132 may have a multilayer structure.

For example, the external electrodes 131 and 132 may include electrode layers 131a and 132a disposed on the body 110 and plating layers 131b and 132b formed on the electrode layers 131a and 132a.

For a more specific example of the electrode layers 131a and 132a, the electrode layers 131a and 132a may be sintered electrodes including a conductive metal and glass, or resin-based electrodes including a conductive metal and glass.

In addition, the electrode layers 131a and 132a may have a form in which a sintered electrode and a resin-based electrode are sequentially formed on the body. In addition, the electrode layers 131a and 132a may be formed by transferring a sheet including a conductive metal onto the body, or may be formed by transferring a conductive metal onto the sintered electrode. In addition, the electrode layers 131a and 132a may be formed as a plating layer or may be a layer formed using a deposition method such as a sputtering method or Atomic layer deposition (ALD).

A material having excellent electrical conductivity may be used as the conductive metal included in the electrode layers 131a and 132a and is not particularly limited. For example, the conductive metal may be at least one of nickel (Ni), copper (Cu), and alloys thereof.

The plating layers 131b and 132b serve to improve mounting characteristics. The type of the plating layers 131b and 132b is not particularly limited, and may be a plating layer including at least one of Ni, Sn, Pd, and alloys thereof, and may be formed of a plurality of layers.

For a more specific example of the plating layers 131b and 132b, the plating layers 131b and 132b may be a nickel (Ni) plating layer or a tin (Sn) plating layer, may have a form in which a nickel (Ni) plating layer and a tin (Sn) plating layer are sequentially formed on the electrode layers 131a and 132a, or may have a form in which a tin (Sn) plating layer, a nickel (Ni) plating layer, and a tin (Sn) plating layer are sequentially formed. In addition, the plating layers 131b and 132b may include a plurality of Ni plating layers and/or a plurality of Sn plating layers. In addition, the plating layers 131b and 132b may have a form in which a Ni plating layer and a Pd plating layer are sequentially formed on the electrode layers 131a and 132a.

A size of the multilayer electronic component 100 is not particularly limited. According to the present disclosure, since it is advantageous for implementing miniaturization and high capacitance, it can be applied to the size of small-sized IT products, and since it can secure high reliability in various environments, it can be applied to the size of automotive electrical products requiring high reliability.

Hereinafter, the present disclosure will be described in more detail through experimental examples, but this is only to help a specific understanding of the disclosure and the scope of the present disclosure is not limited by the experimental examples.

### Experimental Example

First, a first internal electrode paste (P1) having an In content of 1 wt % and a second internal electrode paste (P2) having an In content of 0 wt % were prepared.

In the case of Test No. 1, a capacitance formation portion was stacked using only a ceramic green sheet to which the second internal electrode paste (P2) is applied to form a laminate, and in the case of Test No. 3, a capacitance formation portion was stacked using only a ceramic green sheet to which the first internal electrode paste (P1) is applied to form a laminate.

In the case of Test No. 2, a ceramic green sheet 11 to which the first internal electrode paste (P1) is applied was stacked to form an upper region and a lower region of the capacitance formation portion, and a ceramic green sheet 12 to which the second internal electrode paste (P2) is applied was stacked to form a central portion of the capacitance formation portion, thereby forming a laminate. In this case, a laminate was formed so that the thickness of the upper region and the thickness of the lower region were respectively 50% of the thickness of the central region.

Thereafter, the laminate was cut to fit the size of the multilayer electronic component and then sintered to form a body, and an external electrode was formed on the body to prepare a sample chip.

After polishing a sample chip of each test number to the center in a width direction to expose a cross-section thereof in length and thickness directions (L-T cross-section), a dielectric layer was analyzed in the L-T cross-section, by SEM-EDS, and a region having an average In content of 0.08 at % or more, measured at a center of the dielectric layer in the first direction was divided into an upper region and a lower region, and a region having an average In content of 0.04 at % or less, measured at the center of the dielectric layer in the first direction was divided into a central region. In addition, an average thickness of the capacitance formation portion (Ac) in the first direction is Ta, an average thickness of the upper region (Up) in the first direction is T1, and an average thickness of the lower region (Lp) in the first direction T2, and a (T1+T2)/Ta value was provided in Table 1 below.

In addition, electrostatic capacitance and reliability of sample chips for each test number were evaluated and was provided in Table 1 below.

Electrostatic capacitance was measured for 10 sample chips for each test number, and an average value for each test number was obtained by measuring the electrostatic capacitance using an LCR meter under the conditions of AC voltage 1 Vrms and 1 kHz. The electrostatic capacitance of Test No. 1 was set as a reference value ‘100%’, and relative values for the electrostatic capacitance of Test No. 1 were provided in the case of test Nos. 2 and 3.

Reliability was measured for 40 sample chips per test number, and a high-temperature load test was performed for 100 hours under the conditions of 125° C. and 30V. Samples having insulation resistance of 10KΩ or less were judged as defective, and the number of samples determined to be defective was provided.

TABLE 1

| Test | (T1 + T2)/ | Electrostatic | |
|---|---|---|---|
| No. | Ta | capacitance (%) | Reliability |
| 1 | 0 | 100 | 19/40 |
| 2 | 0.5 | 94.23 | 0/40 |
| 3 | 1.0 | 88.16 | 0/40 |

In the case of Test No. 1 in which a dielectric layer including In was not disposed, the electrostatic capacitance was excellent, but the number of samples determined to be defective in the reliability evaluation was 19, confirming that the reliability was poor.

In the case of Test No. 3 in which In is included in all dielectric layers, the number of samples determined to be defective in the reliability evaluation was 0, indicating that reliability was excellent, but the electrostatic capacitance was inferior to Test No. 1 at 88.16%.

On the other hand, in the case of Test No. 2 in which at least one of the dielectric layers disposed in the upper region and the lower region is a first dielectric layer including In, and at least one of the dielectric layers disposed in the central region is a second dielectric layer not including In or having a lower atomic percentage of average In content than that of the first dielectric layer, it can be confirmed that not only was the reliability excellent, but also the decrease in electrostatic capacitance was suppressed.

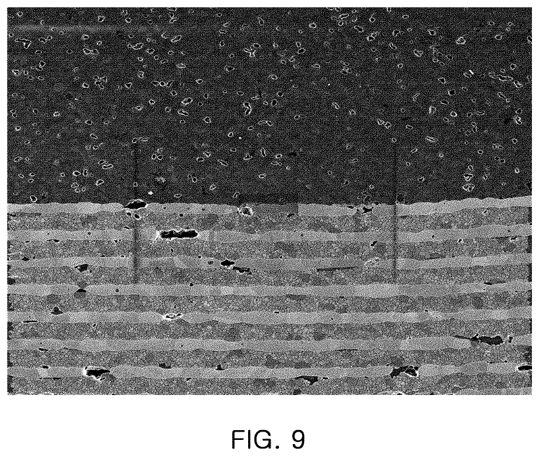

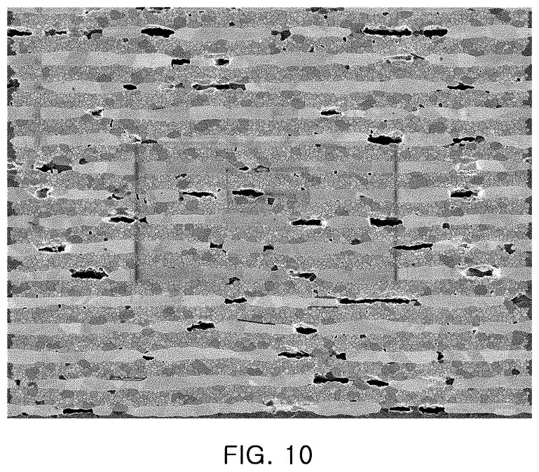

FIG. 9 is an image of an upper region and an upper cover portion of Test No. 2, taken with a SEM. FIG. 10 is an image of a central region of Test No. 2, taken with a SEM. Table 2 below describes the results of analyzing the dielectric layers of the upper region and central region.

After polishing a sample chip of Test No. 2 to a center thereof in a width direction to expose a cross-section in length and thickness directions (L-T cross-section), central regions (Ar1, Ar2) of a dielectric layer in a thickness direction in the L-T cross-section were analyzed by SEM-EDS, to measure an In content, which is provided in Table 2 below.

In addition, an image obtained by scanning the L-T cross-section with a scanning electron microscope (SEM) was analyzed using ImageJ for 100 or more dielectric grains to obtain maximum Ferret diameters, minimum Ferret diameters, and sizes of each dielectric crystal grain and core, so that an average size of the dielectric grain and an average size of the core were provided in Table 2 below.

The area and number of a secondary phase were measured using SEM-EDS in the L-T cross section at a unit area (100 μm², 10 μm×10 μm), and the values are provided in Table 2 below.

TABLE 2

| | | | | | The number |
|---|---|---|---|---|---|
| | | Average | Average | Area of | of |
| | In | grain | core | secondary | secondary |
| Division | content | size | size | phase | phase |
| Upper | 0.11 at % | 178 nm | 110 nm | 1.15 μm² | 15 |
| region | | | | | |
| Central | 0.01 at % | 192 nm | 100 nm | 1.33 μm² | 20 |
| region | | | | | |

Referring to FIGS. 9 and 10 and Table 2 above, it can be confirmed that the dielectric layer in the upper region includes In, but the dielectric layer in the central region substantially does not include In, and the average grain size in the upper region is smaller than that in the central region, but the average core size in the upper region is larger than that in the central region. In addition, it can be confirmed that the dielectric layer in the upper region suppresses secondary phase generation by including In, thereby reducing the area and number of secondary phases.

As set forth above, one of the effects of the present disclosure, by controlling an In content of a dielectric layer depending on a position at which the dielectric layer is disposed, reliability of a multilayer electronic component may be improved.

As one of the many effects of the present disclosure, it is possible to suppress a decrease in electrostatic capacitance due to the addition of In.

However, various advantages and effects of the present disclosure are not limited to the above-described contents, and can be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A multilayer electronic component, comprising:
a body including:
a capacitance formation portion in which a dielectric layer and internal electrodes are alternately disposed in a first direction,
a first cover portion disposed on a first surface of the capacitance formation portion in the first direction, and
a second cover portion disposed on a second surface of the capacitance formation portion opposing the first surface in the first direction; and
an external electrode disposed on the body,
wherein the capacitance formation portion includes:
a first region adjacent to the first cover portion,
a second region adjacent to the second cover portion, and
a central region disposed between the first region and the second region,
the dielectric layer includes:
a first plurality of dielectric layers disposed in the first region,
a second plurality of dielectric layers disposed in the second region, and
a third plurality of dielectric layers disposed in the central region,
at least one dielectric layer among the first plurality of dielectric layers and the second plurality of dielectric layers is a first dielectric layer that includes In, and
at least one dielectric layer among the third plurality of dielectric layers is a second dielectric layer that (i) is free of In, or (ii) includes In at an average In content, at %, that is lower than an average In content, at %, of the first dielectric layer.

2. The multilayer electronic component of claim 1, wherein the first dielectric layer has an average In content of 0.08 at % or more measured at a center of the first dielectric layer in the first direction, and the second dielectric layer has an average In content of 0.04 at % or less measured at a center of the second dielectric layer in the first direction.

3. The multilayer electronic component of claim 2, wherein the second dielectric layer has an average In content of 0.01 at % or less.

4. The multilayer electronic component of claim 1, wherein the first dielectric layer has an average In content of 0.08 at % or more and 0.12 at % or less measured at the center of the first dielectric layer in the first direction.

5. The multilayer electronic component of claim 1, wherein a dielectric layer among the first plurality of dielectric layers and the second plurality of dielectric layers has an average In content of 0.08 at % or more measured at the center of the dielectric layer among the first plurality of dielectric layers and the second plurality of dielectric layers in the first direction, and a dielectric layer among the third plurality of dielectric layers has an average In content of 0.04 at % or less measured at the center of the dielectric layer among the third plurality of dielectric layers in the first direction.

6. The multilayer electronic component of claim 5, wherein when an average thickness of the capacitance formation portion in the first direction is Ta, an average thickness of the first region in the first direction is T1, and an average thickness of the second region in the first direction is T2, (T1+T2)/Ta is 0.3 or more and 0.7 or less.

7. The multilayer electronic component of claim 6, wherein Ta, T1 and T2 satisfy 0.15≤T1/Ta≤0.35 and 0.15≤T2/Ta≤0.35.

8. The multilayer electronic component of claim 1, wherein the average In content of the first dielectric layer is at least twice the average In content of the second dielectric layer.

9. The multilayer electronic component of claim 1, wherein an average size of dielectric crystal grains included in the first region and the second region is smaller than an average size of dielectric crystal grains included in the central region.

10. The multilayer electronic component of claim 1, wherein the dielectric layer includes dielectric crystal grains comprising a first dielectric grain including a first core and a first shell, and a second dielectric grain including a second core and a second shell,
at least one dielectric layer among the first plurality of dielectric layers and second plurality of dielectric layers includes the first dielectric grain,
at least one dielectric layer among the third plurality of dielectric layers includes the second dielectric grain, and
an average size of the first core is larger than an average size of the second core.

11. The multilayer electronic component of claim 1, wherein the dielectric layer includes secondary phases,
at least one dielectric layer among the first plurality of dielectric layers and second plurality of dielectric layers includes a first average number of the secondary phases,
at least one dielectric layer among the third plurality of dielectric layers includes a second average number of the secondary phases, and
the first average number is smaller than the second average number.

12. The multilayer electronic component of claim 1, wherein the dielectric layer includes secondary phases,
at least one dielectric layer among the first plurality of dielectric layers and second plurality of dielectric layers includes the secondary phases,
at least one dielectric layer among the third plurality of dielectric layers includes the secondary phases, and
an average area of the secondary phases included in the at least one of the dielectric layer among the first plurality of dielectric layers and second plurality of dielectric layers is smaller than an average area of the secondary phases included in the at least one of the dielectric layer among the third plurality of dielectric layers.

13. The multilayer electronic component of claim 1, wherein an average porosity of at least one dielectric layer among the first plurality of dielectric layers and the second plurality of dielectric layers is lower than an average porosity of at least one dielectric layer among the third plurality of dielectric layers.

14. The multilayer electronic component of claim 1, wherein an average In content measured at a center of the first cover portion and the second cover portion is 0.04 at % or less.

15. The multilayer electronic component of claim 1, wherein the internal electrodes include a 1-1 internal electrode and a 2-1 internal electrode disposed with the first dielectric layer interposed therebetween,
the 1-1 internal electrode and the 2-1 internal electrode include Ni and In, and
at least a portion of In included in the 1-1 internal electrode and the 2-1 internal electrode exists in an alloy form with Ni.

16. A multilayer electronic component, comprising:
a body including:
a capacitance formation portion in which a dielectric layer and internal electrodes are alternately disposed in a first direction; and
an external electrode disposed on the body,
wherein the capacitance formation portion includes:
a central region,
a first region disposed on a first surface of the central region, and
a second region disposed on a second surface of the central region, where the second surface of the central region opposes the first surface of the central region in the first direction,
the dielectric layer includes:
a first dielectric layer having a first average In content at a center of the first dielectric layer in the first direction, where the first dielectric layer is disposed in the first region, the second region, or both, and
a second dielectric layer having a second average In content at a center of the first dielectric layer in the first direction, where the second dielectric layer is disposed in the central region, and the first average In content is different from the second average In content.

17. The multilayer electronic component of claim 16, the first average In content is more than the second average In content.

18. The multilayer electronic component of claim 16, wherein the first average In content is 0.08 at % or more, and the second average In content is 0.04 at % or less.

19. The multilayer electronic component of claim 16, wherein when an average thickness of the capacitance formation portion in the first direction is Ta, an average thickness of the first region in the first direction is T1, and an average thickness of the second region in the first direction is T2, (T1+T2)/Ta is 0.3 or more and 0.7 or less.

20. A method of manufacturing a multilayer electronic component, comprising:
applying a first internal electrode paste on a first ceramic green sheet;
applying a second internal electrode paste on a second ceramic green sheet, and
disposing the first ceramic green sheet, on which the first internal electrode paste is applied, on surfaces of the second ceramic green sheet, on which the second internal electrode paste is applied, to form a laminate,
wherein the first internal electrode paste includes In, and an In content of the first internal electrode paste is different from an In content of the second internal electrode paste.

21. The method of claim 20, wherein the second internal electrode paste is free of In.

22. The method of claim 20, wherein the In content of the first internal electrode paste is 0.5 to 1.5 wt %, based on a total weight of the first internal electrode paste.

23. The method of claim 20, wherein the In content of the first internal electrode paste is higher than the In content of the second internal electrode paste.

24. The method of claim 20, further comprising:
firing the laminate to form a body, and
applying an external electrode paste on the body to form the multilayer electronic component.
